(19) United States
(12) Patent Application Publication
(10) Pub. No.: US 2026/0227197 A1
(43) Pub. Date: Aug. 6, 2026

(54) PREDICTION-BASED RECOMMENDATIONS FOR MANAGING REAL-TIME CONGESTION AT ELECTRIC VEHICLE (EV) CHARGING STATIONS

(71) Applicant: American Honda Motor Co., Inc., Torrance, CA (US)

(72) Inventors: David CUN, Fountain Valley, CA (US); Joslyn Elena GARCIA, Redondo Beach, CA (US)

(21) Appl. No.: 19/046,714

(22) Filed: Feb. 6, 2025

(51) Int. Cl. G01C 21/36; G01C 21/34

(52) U.S. Cl. CPC G01C 21/3697; G01C 21/3415; G01C 21/3492; G01C 21/3602; G01C 21/3647; G01C 21/3679; G01C 21/3691

(57) ABSTRACT

Systems and methods for facilitating and optimizing re-fueling station selection. A server may receive information about a charging station’s current congestion levels. The server can predict whether the congestion is due to an impromptu event in a local area around the charging station and estimate how much longer the event will affect congestion levels at the charging station. This information can be used to generate real-time recommendations for selecting a charging station destination to a driver.

### BACKGROUND

The present disclosure generally relates to offering drivers of electric vehicles (EVs) intelligent insights regarding the likely wait times for a charging station in a particular geographic area, and more particularly, to a system and method for real-time predictions identifying why an unplanned higher-than-normal congestion event is occurring and its estimated duration, in order to facilitate the charging station selection experience for drivers.

Despite the popularity and several initiatives to transition to zero-emission vehicles, the long charging time, the lack of an extensive charging network, and difficulty in optimally crafting routes with charging requirements remain major impediments to the uptake of EVs. Such challenges will be further amplified disproportionately with a sharp growth of the number of EVs in the next few years.

For example, when considering the challenge of a longer EV charging time compared to traditional gas stations, any queuing in the charging stations can rapidly accumulate to a much higher wait time. EV owners are asked to tolerate higher waiting times compared to conventional car owners, even when the charging station has multiple “fast chargers”. Nevertheless, during periods when drivers face unexpected or unscheduled periods of congestion, the wait time can become excessive.

Current charging infrastructure development rates are insufficient to meet the sharply increasing demand. Although establishing new charging stations are important to increase charging options, simply increasing the number of stations and outlets will not linearly meet the demand and address short-notice / impromptu event related queues. It is thereby crucial to optimally utilize the existing stations, and new ways of charging (e.g., route selection, charging time planning, and alternative charging options) and awareness of queuing traffic and times.

While maps of charging stations between user-specified locations are available, crafting routes with the most appropriate charging option in the context of real-time ongoing traffic is a challenging task. Planning routes considering the EVs’ refueling constraints and stations’ properties (e.g., number of outlets, charging time) with minimizing wait time and detour is computationally expensive. It is even more challenging when other factors are considered, such as the nearby points of interest, vehicle energy consumption, station availability and failures, the dynamic, short-notice factors impacting traffic flow, and the road network topology. In some cases, drivers’ routes should be altered to pass a suitable station due to chance events, but they may not appreciate this during their day-to-day planning when faced with unscheduled or irregular incidents that trigger congestion in and around a particular charging station.

Therefore, there is a need for a system that improves EV driver awareness of likely causes of unexpected traffic at/around a charging station, and facilitates selection of alternate charging stations when appropriate to address the shortcomings described above.

### SUMMARY

The disclosed embodiments provide methods and systems for facilitating a driver’s selection of charging stations based on intelligent and dynamic predictions of events that are likely causing or contributing to higher-than-normal congestion at a particular charging station and recommending rerouting when such events are anticipated to exceed a preselected threshold.

In one aspect, a method of generating intelligent and dynamic predictions to facilitate vehicle charging station selections is disclosed. The method may include receiving, at a charging guidance system and from a first electric vehicle (EV), a status request for a first charging station. The method further includes receiving, at the charging guidance system and from a second EV located on-site at the first charging station, a first dataset collected via an onboard sensor of the second EV, as well as determining, at the charging guidance system and based on the first dataset, that there is a greater-than-average level of vehicle congestion at the first charging station. The method can also include receiving, at the charging guidance system, a second dataset describing one or more events currently occurring within a local vicinity of the first charging station. In addition, the method includes predicting, at the charging guidance system, that a first event of the one or more events is most likely to be causing the vehicle congestion, and further causing the first EV to present a message to its driver identifying the first event as a potential cause of the vehicle congestion at the first charging station.

In another aspect, the disclosure provides a non-transitory computer-readable medium storing software comprising instructions executable by one or more computers which, upon such execution, cause the one or more computers to generate intelligent and dynamic predictions to facilitate vehicle charging station selections by performing the following: (1) receiving, at a charging guidance system and from a first electric vehicle (EV), a status request for a first charging station; (2) receiving, at the charging guidance system and from a second EV located on-site at the first charging station, a first dataset collected via an onboard sensor of the second EV; (3) determining, at the charging guidance system and based on the first dataset, that there is a greater-than-average level of vehicle congestion at the first charging station; (4) receiving, at the charging guidance system, a second dataset describing one or more events currently occurring within a local vicinity of the first charging station; (5) predicting, at the charging guidance system, that a first event of the one or more events is most likely to be causing the vehicle congestion; and (6) causing the first EV to present a message to its driver identifying the first event as a potential cause of the vehicle congestion at the first charging station.

In yet another aspect, the disclosure provides a system for generation of intelligent and dynamic predictions to facilitate vehicle charging station selections, the system comprising one or more computers and one or more storage devices storing instructions that may be operable, when executed by the one or more computers, to cause the one or more computers to: (1) receive, at a charging guidance system and from a first electric vehicle (EV), a status request for a first charging station; (2) receive, at the charging guidance system and from a second EV located on-site at the first charging station, a first dataset collected via an onboard sensor of the second EV; (3) determine, at the charging guidance system and based on the first dataset, that there is a greater-than-average level of vehicle congestion at the first charging station; (4) receive, at the charging guidance system, a second dataset describing one or more events currently occurring within a local vicinity of the first charging station; (5) predict, at the charging guidance system, that a first event of the one or more events is most likely to be causing the vehicle congestion; and (6) cause the first EV to present a message to its driver identifying the first event as a potential cause of the vehicle congestion at the first charging station.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

### BRIEF DESCRIPTION OF THE DRAWINGS

The embodiments may be better understood with reference to the following drawings and description. The components in the figures are not necessarily to scale, emphasis instead being placed upon illustrating the principles of the embodiments. Moreover, in the figures, like reference numerals designate corresponding parts throughout the different views.

FIG. 1 is a schematic flow diagram showing an example of a process for identifying congestion levels at a charging station and generating predictions as to events contributing to any congestion, in accordance with an embodiment of the disclosure;

FIG. 2 shows an example by which a charging guidance system can receive real-time, on-site data related to current congestion levels at a charging station, in accordance with an embodiment of the disclosure;

FIG. 3 depicts a driver of an electric vehicle (EV) interacting with a charging assistant to learn a selected charging station is experiencing higher-than-normal congestion, in accordance with an embodiment of the disclosure;

FIG. 4 is a schematic diagram illustrating a process by which local data can be pulled for processing by a prediction module in order to identify a cause of the congestion, in accordance with an embodiment of the disclosure;

FIGS. 5A – 5B depict the charging assistant presenting a recommendation to the driver of the EV based on the prediction, in accordance with an embodiment of the disclosure; and

FIG. 6 is a flow chart of a process of generating intelligent and dynamic predictions to facilitate vehicle charging station selections, in accordance with an embodiment of the disclosure.

### DETAILED DESCRIPTION

Electric Vehicle (EV) driver charging behavior is the result of a large array of factors. Typically, drivers elect to charge at home or at their workplace, or more broadly, they might charge either at their point of origin or their destination, if such locations offer charging services. Outside of these options, charging behavior can revolve around “enroute charging” where public charging facilities are used. A driver’s decision of using or selecting stations can depend on detour distances or travel times involved, as well as queuing (or wait times) at desired fast-charging stations. In some cases, travelers can access information services that can help them keep alerted of planned or scheduled congestion along all routes and at each charging station. Of course, congestion can also occur more spontaneously, such that a driver makes plans to charge at a particular station but then finds there is greater-than-normal level of congestion (i.e., longer-than-usual wait time), which can negatively impact the EV experience.

In order to address these and other drawbacks to the charging process, the disclosed embodiments provide methods and systems for intelligently modulating the information, including recommendations, presented by the EV’s charging station finder system and virtual assistant (“station finder”) to the driver. In one example, the station finder can be configured to remove or deprioritize charging station recommendations that are around crowded “pop-up” events (unscheduled in advance, and/or only apparent on the day-of the event, or other short-notice events/incidents) or are experiencing access congestion or longer charging wait times due to other unplanned events. These types of events will be collectively referred to herein as “impromptu events”.

In different embodiments, these events may be detected via onboard sensors of those vehicles that are already near to these crowded event areas. The sensors can detect (e.g., through camera and noise sensors) that such areas are crowded, or that a particular charging station has an abnormally high aggregation of vehicles, and then share this data as part of a notification to a remote EV charging management server. In this way, EVs can be notified by the server of the crowding and can choose alternative charge stations. In another example, other vehicles may provide data to the remote server that enable the station finder to generate insights as to the reasons why a charging station is congested or unavailable, as well as the likelihood that the reason will dissipate in some desirable period, and recommendations for alternate charging solutions. In some embodiments, local data sources can provide context for impromptu events. In some embodiments, an EV can automatically browse the internet for events in the local area to attempt to provide a most-likely (highest likelihood) reason to a user as to why a specific charge station has been determined crowded by camera/sound sensors. In some embodiments, the system can also be configured to provide a warning to a user, when no sensor data is available near the area, that a specific charge station is predicted to be crowded due to a specific event.

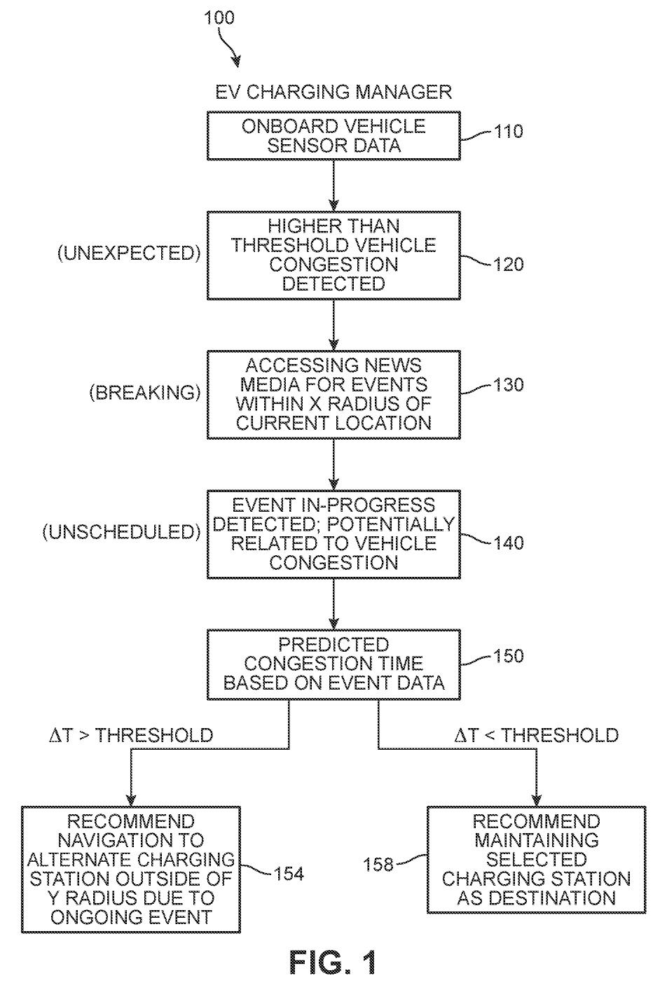

As an introduction to the proposed prediction and recommendation EV charging optimization systems, FIG. 1 depicts a schematic flow diagram of a process 100 for generating real-time recommendations to a driver based on intelligent congestion context event predictions. In a first stage 110, onboard sensor data from one or more vehicles in and around a particular charging station is collected and shared with a remote EV charging management server. In a second stage 120, the server determines, based on the sensor data, that there is a higher-than-expected/anticipated level of congestion within a pre-selected range of the charging station (e.g., which generally translates to a longer and/or a longer-than-average wait time or greater-than-usual number of vehicles at the charging station for the current time of day and day of the week. In some embodiments, this determination can be shared with an EV’s onboard charging station finder system. At a third stage 130, the remote server – or in some cases, the EV’s local station finder -- can initiate a current news and media search related to the area (e.g., within a preset radius) around the selected charging station destination, including a search across a variety of sources and types of events. In a fourth stage 140, one or more events-in-progress may be identified that may be connected to or contribute to the congestion or longer wait times (“congestion context event(s)”). The server (or EV station finder) can then, in a fifth stage 150, pass the event(s)-related information to a prediction module that can estimate how long the effect of the event will most likely impact the wait times/congestion in the area. If the duration exceeds some pre-designated period of time (e.g., a duration selected by the driver as being too long to wait (as a personal preference), or by the EV systems based on an assessment that it would be more efficient energy consumption-wise to move on to an alternate station), a recommendation engine can output a first recommendation type 154 to the driver that they proceed to an alternate charging station outside of the impacted area, and offer navigation assistance for the re-routing. On the other hand, if the duration is less than the pre-designated period of time, the recommendation engine can output a second recommendation type 158 whereby the driver is encouraged to maintain their original charging station destination.

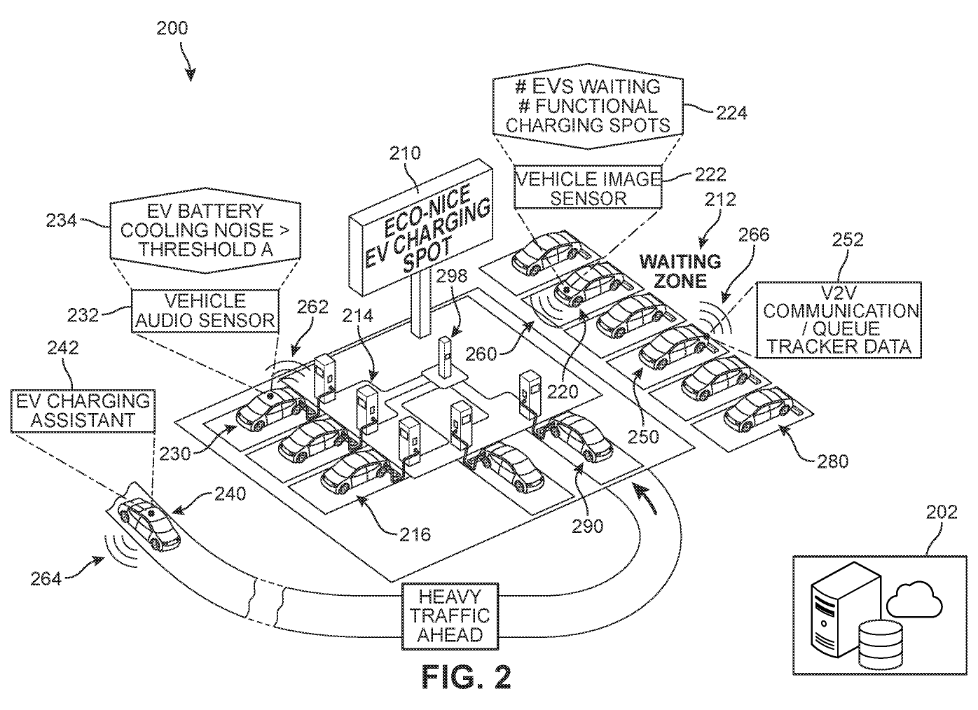

Additional details regarding this process will be provided now with reference to an example scenario shown in FIGS. 2, 3, and 4. In FIG. 2, an example first charging station (“first station”) 210 is depicted. The first station 210 is situated in a first neighborhood area 200. At this time, there are a higher-than-normal number of queuing vehicles 280 stationed in a waiting zone 212 associated with the first station 210. In addition, all charging spots for accessing a charger supply 214 are being used. Nevertheless, a first EV 240 is currently on its way toward the first station 210, which is enroute to its final destination, intending to refuel at a location that seems to represent a convenient stopping point. A driver of the first EV 240 can engage their onboard virtual charging assistant 242 (or station finder app) to confirm the first station 210 as their desired target destination. In response, the charging assistant 242 can transmit a request to a remote charging management server (“server”) 202 for the most up-to-date information related to the first station 210.

For example, in some embodiments, EVs that are currently “on site” or otherwise near to the first station 210 can collect data that may be used to generate insights regarding its status, including charging vehicles 290 and queued vehicles 280. In one example, a first on-site EV 220 is located in the waiting zone 212 for the charging station and can ‘observe’ or otherwise capture image data of its surrounding environment via one or more onboard image sensors (“cameras”) 222. In different embodiments, image data can capture a first set 224 of features, such as the number of EVs in the queue, the number of charging spots, how long each vehicle must wait before obtaining a charging spot, and when vehicles arrive and depart from the station. Similarly, a second on-site EV 230 that is located in a charging zone 216 of the first station 210 can ‘listen’ or otherwise capture audio data of its surrounding environment via one or more onboard audio sensors (“microphones”) 232. In different embodiments, audio data can capture a second set 234 of features, such as the level of noise around the station and how much of the noise is likely generated by active battery cooling operations of nearby vehicles (e.g., running of fans), particularly in warmer weather or regions and/or in charging stations that are underground or otherwise surrounded by retaining walls, such that sound emissions in that area remain relatively contained. This audio data can offer a meaningful insight into the overall estimation the number of vehicles that are being charged. In addition, a third on-site EV 250 that is located in the waiting zone 212 can communicate with other vehicles (e.g., over networks (260, 262, 264, 266), via V2V communication systems 252 as well as charging station’s computing system 298 to monitor and track real-time charging activities at the station.

As a general matter, vehicle-to-vehicle (V2V) communication refers to an automobile technology designed for dedicated short-range communication (DSRC) to allow vehicles to communicate with one another. V2V communications utilizes all forms of wireless components and can be used to form a vehicular ad hoc network on the road (VANET). In the US, the "Wireless Access for Vehicular Environments" V2V standard is based upon the lower-level IEEE 802.11p standard where it uses a region of the 5.9GHz band. However, other protocols can be used. Vehicular communication refers to the wireless communication mechanism used in the applications of the vehicular network. Communications can take place directly among moving vehicles in vehicle-to-vehicle (V2V) form or between vehicles and fixed road-side equipment.

In different embodiments, this type of on-the-ground system data can capture a third set of features (see 224 and 234 for first and second sets of features, respectively), such as the number of active charging spots, the traffic in and out of the station, the number of vehicles charging, the number of vehicles with upcoming reservations to charge at this station, etc. Other vehicle sensor data, including location sensors or GPS, can also supply pertinent information. For example, a vehicle’s geolocation (or the geolocation of a mobile device linked to the vehicle and driver) can be used to determine how many electric vehicles are idling near the charging station, with the deduction being these vehicles are each waiting for an available charging spot at that station.

In different embodiments, the vehicles described herein may be non-autonomous vehicle, semi-autonomous vehicles, or fully autonomous vehicles, for example, as defined by National Highway Traffic Safety Administration (NHTSA). Examples of the vehicles may include, but are not limited to, a three-wheeler vehicle, a four-wheeler vehicle (or a vehicle with any number of wheels), a hybrid vehicle, or a vehicle with autonomous drive capability that uses one or more distinct renewable or non-renewable power sources. The vehicles may use renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. The vehicles may have load carrying capabilities that uses one or more distinct trailers. It should be noted here that the vehicles shown are four-wheeler vehicles, which are merely an example.

As a general matter, vehicle(s) used in the embodiments herein may include suitable logic, circuitry, and/or interfaces, which may be configured to receive fuel (e.g., gas, electric charge, hydrogen, etc.) to run different electronic or electrical components/devices of the vehicle. The vehicle may be a non-autonomous, a semiautonomous, or an autonomous vehicle. Examples of the vehicle may include, but are not limited to, an electric vehicle, a hybrid vehicle, internal combustion vehicle, hydrogen powered vehicle, and/or a vehicle that uses a combination of one or more distinct renewable and non-renewable power sources. Thus, the term EV is used inclusively to refer to plug-in electric vehicles that are variously referred to in the literature as plug-in hybrid electric vehicles (PHEVs), extended range electric vehicles (EREVs), all-electric vehicles (AEVs), battery electric vehicles (BEVs), and plug-in electric vehicles (PEVs), and other hybrid vehicles. In different embodiments, the vehicle that uses renewable and non-renewable power sources may include a fossil fuel-based vehicle, an electric propulsion-based vehicle, a hydrogen fuel-based vehicle, a solar-powered vehicle, and/or a vehicle powered by other forms of alternative energy sources. The vehicle may further include an electronic apparatus such as an onboard computing system that may be configured to communicate with a remote server over a communication network.

In different embodiments, the communication network may be one of a wired connection or a wireless connection. Examples of the communication network may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the network environment may be configured to connect to the communication network in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

In different embodiments, the onboard computing system of a vehicle may be configured to communicate with one or more remote systems over a network. The network may comprise any wide area network, local area network or other suitable network. In some cases, network may be the Internet. The onboard computing system may communicate, for example, with one or more external database systems or remote servers. An external database system can include a server (including processors and memory) and a database, and the external database system may store various kinds of information, including, but not limited to: navigation information, geospatial information, road conditions (for example, real-time traffic patterns), weather information (including, for example, rain, snow, ice and/or flooding forecasts), as well as other kinds of information. It may be appreciated that onboard computing system may both send and receive information to and from these remote databases. Moreover, it may also be appreciated that in other embodiments, one or more of these databases (or parts of the databases) may be locally disposed within a vehicle’s local systems.

The electronic apparatus associated with the vehicle may include suitable logic, circuitry, interfaces, and/or code that may be configured to communicate with the server on behalf of the vehicle over the communication network. The electronic apparatus may be an in-vehicle infotainment system that may be integrated with the vehicle. The in-vehicle infotainment system may include suitable logic, circuitry, interfaces and/or code that may be configured to render at least an audio-based data, a video-based data, and/or a user interface to an occupant of the vehicle. The in-vehicle infotainment system may be configured to execute one or more operations associated with the vehicle. Examples of the in-vehicle infotainment system may include, but are not limited, an entertainment system, a navigation system, a vehicle user interface (UI) system, an Internet-enabled communication system, and other entertainment systems. In some embodiments, the electronic apparatus may be the electronic control unit (ECU) of the vehicle or an electronic dashboard of the vehicle. In other embodiments, the electronic apparatus may be a portable device that may be associated with the occupant of the vehicle. Examples of the portable device may include, but are not limited to, a computing device, a smartphone, a cellular phone, a mobile phone, a gaming device, a camera device, a computer work-station, a personal digital assistant (PDA) and/or a consumer electronic (CE) device.

Furthermore, as discussed herein, vehicles described herein may also include one or more vehicle sensors comprising a data acquisition system. In one example, vehicles may also include an onboard diagnostics (OBD) system that may track and process various vehicle sensor information. In some cases, one or more systems for a vehicle may retrieve sensory data from the OBD system rather than directly from the sensors themselves. For example, sensors can include microphones, cameras, motion sensors, status sensors, proximity sensors and external cameras, light detection and ranging system (LIDAR) and/or RADAR based sensors. It may be appreciated that different sensors can be used with various vehicles, and a single vehicle need not include all of the following sensors.

Generally, microphones may include any kind of microphones known in the art for use in vehicles or mobile devices. A vehicle may include microphones embedded in a dashboard, in a rearview mirror, in the grill, or other locations. Microphones in a vehicle may be useful for speakerphone functionality and for communicating audibly with an onboard intelligent voice assistant. In addition, cameras may include any kind of cameras known in the art for use in vehicles or mobile devices, including thermal imaging and infrared, as well as RGB cameras. A vehicle may include cameras in a dashboard or rearview mirror, along the exterior surfaces of each door or pillar, along the car roof, or adjacent to the side bumper(s), for example. In some cases, onboard computing system may include machine learning (ML) algorithms trained to detect features associated with specific traffic patterns, road conditions, weather, and vehicles in images. Other onboard sensors may include devices such as laser rangefinders, radar, global positioning system (GPS), and radio frequency identification transceivers. Sensor systems may also be used to sense objects around the vehicle, such as other vehicles, charging paraphernalia, pedestrians, bicyclists, buildings, traffic signs, traffic lights, intersections, bridges, and the like.

In different embodiments, one or more of the different sets of data features that are collected by vehicles and systems associated with a charging station can be shared over a network with the remote server 202, collectively referred to herein as a “data snapshot” for the charging station. In one example, the data can be shared over regular interval updates (e.g., every 30 seconds, every minute, every hour, etc.) or in a substantially continuous stream. The remote server 202 can then leverage this data and determine, based on such “live” on-site data, an estimate of the current level of congestion around the charging station and/or the queue length for vehicles looking to charge at the station. For example, with respect to image data, image processing can be performed to prepare the data for review by a congestion level monitor module at the server 202. In different embodiments, image signal processing algorithms and/or software can perform pre-processing and processing of the captured image data. For example, the image input can be cleansed and normalized. In different embodiments, various image processing algorithms and/or software may be used with captured image data. In one embodiment, the image processing algorithms perform compression, artifact correction, noise reduction, color corrections, geometric corrections, imager non-uniformity correction, etc., and various image processing enhancement operations on the image content. The algorithms can be implemented as software running on a processor, DSP processor, special purpose ASIC and/or FGPA's. The image processing algorithms can also be a mixture of custom developed algorithms and libraries. The image processing algorithms can further be arranged in any logical sequence, with potential changes in the sequence of processing or parameters governing the processing determined by image type, computational requirements or outputs from other algorithms.

In some embodiments, image processing may also include machine learning techniques that can be used to discriminate between features and to identify objects, for example via image recognition and object detection software. Such techniques may also include machine vision algorithms that perform, among other operations, symbol and logo recognition, general shape recognition, as well as object classification. The machine vision algorithms may reside on a different system belonging to a different entity than the image processing algorithms or the application software. The machine vision algorithms, which are applied to identify an object in the digital image, may include computer vision algorithms such as image analysis algorithms that may use a feature detector or a combination of detectors. For example, texture detectors and edge detectors known to those skilled in the art may be used. If both specific texture and specific edges are detected in a set of images, then an identification may be made. One non-limiting example of an edge detection method includes the Canny™ algorithm available in computer vision libraries such as Intel™ OpenCV. Texture detectors may use known algorithms such as texture detection algorithms provided by Matlab™. Some non-limiting examples of object detection algorithms include R-CNN, SPP, Fast R-CNN, Faster R-CNN, Feature Pyramid networks, RetinaNet (Focal loss), Yolo Framework — Yolo1, Yolo2, Yolo3, and SSD.

Once the image data has been processed, relevant features may be extracted for use as input for a vehicle identification module that can apply one or more of a wide range of available algorithms for classifying vehicles in images. As one non-limiting example, the vehicle identification module may divide the images into many small-size grids, and the features from all these grids are concatenated to identify vehicular features. In some embodiments, one or more feature classification techniques can be used by the modules to detect and identify vehicles, including but not limited to an artificial neural network (ANN), convolutional neural network (CNN), random forest (RF) machine learning model, support vector machine (SVM), decision table, Naïve Bayes, etc. Similarly, audio data can be processed and scanned to determine whether particular sound types (e.g., electric vehicle charging-related audio) are present, and to what degree to determine how busy a charging station is likely to be.

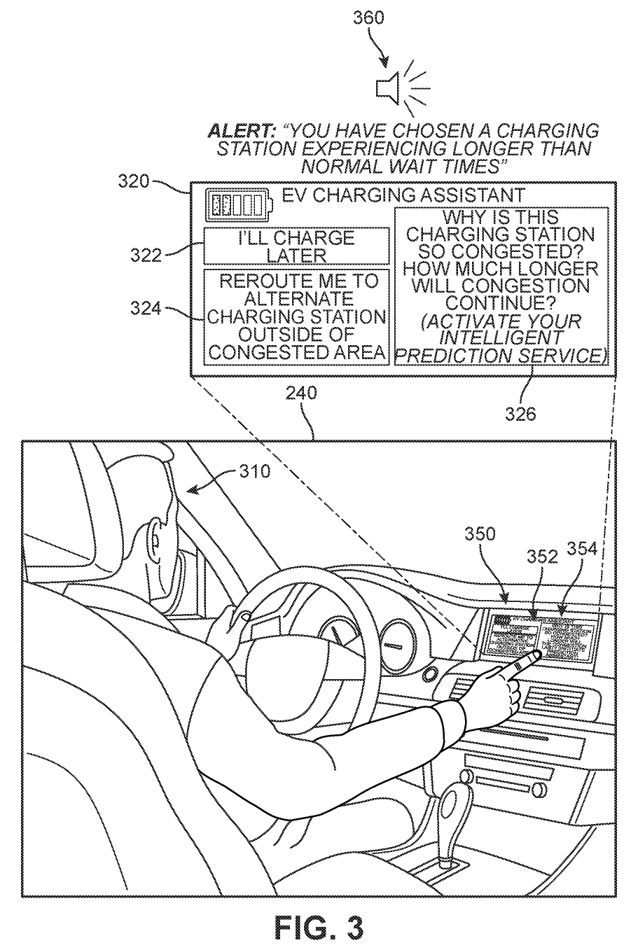

Moving now to FIG. 3, in cases where the congestion/queue lengths are above a predesignated threshold, the server 202 can send a message to first EV’s charging assistant 320 which can trigger one or more further actions in response to the message. In FIG. 3, a view of an interior of the first EV 240 and a first driver 310 (who may also be a passenger in the case of autonomous vehicles) is illustrated. As a general matter, first EV 240 may include an onboard computing system 350. Onboard computing system 350 may comprise a single computing device, or a network of multiple computing devices. Onboard computing system 350 may be associated with one or more electronic control units (ECUs). Onboard computing system 350 can include one or more processors and memory. Memory may comprise a non-transitory computer readable medium. Instructions stored within memory may be executed by the one or more processors.

For clarity, some of the vehicle systems of the embodiments may reside within a single onboard computing system 350. However, it may be appreciated that in some embodiments, one or more of these systems may be separate and may not comprise part of a single computing system. Instead, two or more systems may each comprise their own processors and/or memory, as well as components facilitating communication with other systems. As noted above, in different embodiments, first EV 240 may also include one or more communication components. Communication components may include cellular network components for communicating over cellular networks, Wi-Fi components for communicating over Wi-Fi networks, and other communication components.

As illustrated in FIG. 3, in different embodiments, the first EV 240 can further include a driver interface system 352. The driver interface system 352 may be used to interface with the driver or other occupant of the vehicle. To achieve this interface, the interface systems may include input and output devices including but not limited to keyboards, touchscreens, microphones, scroll wheels, displays, speakers, and haptic systems. Driver interface system 352 may be configured to display or otherwise present options and settings as well as information about external road conditions around the first EV 240 or other motor vehicles nearby. For example, some aspects of the driver interface system 352 can be presented via a vehicle display screen 354. In other embodiments, a mobile device such as a tablet or mobile phone can be connected to the onboard computing system 350 and configured to present aspects of the driver interface system 352. In one embodiment, the driver interface system 352 can be configured to allow first driver 310 to view alternate driving actions or operational options generated by the station finder charging assistant 320.

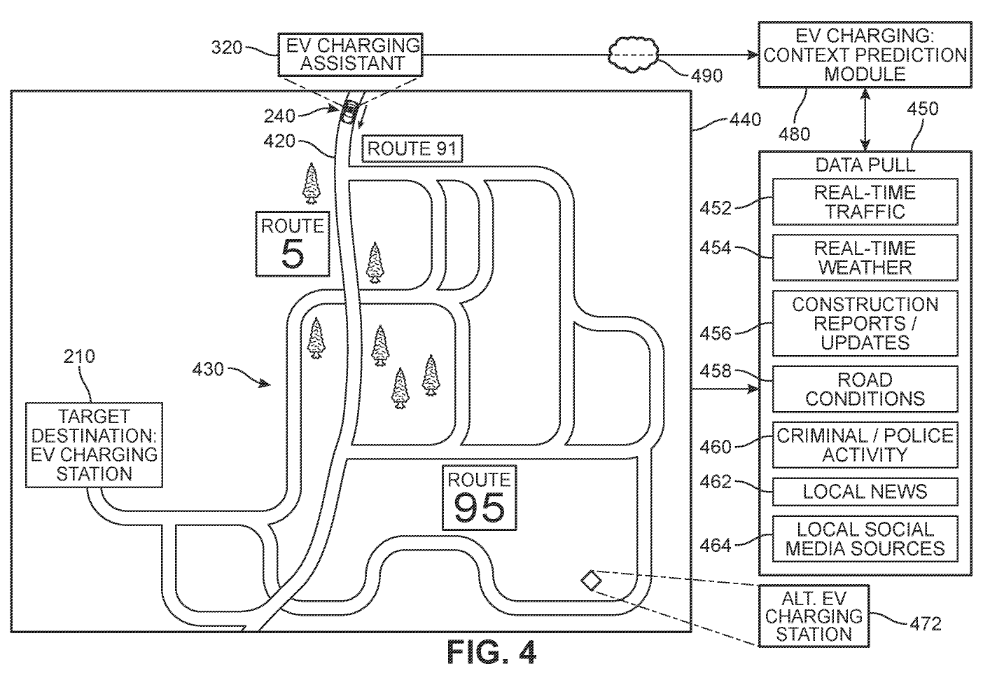

In different embodiments, the charging assistant 320 is or incorporated in an intelligent system that is implemented, managed, or maintained by the onboard computing system 350 with reference to sensor systems and interface systems, as discussed above. The onboard computing system 350 may also include control systems configured to use or otherwise respond to the data gathered by the sensor systems to control features of the vehicle that may affect vehicle safety, such as image data, navigation, temperature, and noise levels. In some embodiments, charging assistant 320 can initiate different actions or operations in response to data received from the remote server. For example, charging assistant 320 can select or determine a recommendation based on a prediction generated by its local prediction module (see FIG. 4) or a prediction received from a prediction module of the remote server.

It should be understood that the functions described as being performed by charging assistant 320 and/or onboard computing system 350 or components thereof can reside in a vehicle’s onboard computing system, while in some other embodiments, these operations can be performed by components located in or accessed via a mobile user device connected to the vehicle’s computing systems. In still other examples, these operations can be performed via other components that can reside remotely (e.g., on a cloud-based server) and are accessed by the vehicle and/or user device over a network. In other words, although the drawings describe operations performed by charging assistant 320 locally (i.e., at the vehicle computing system), embodiments herein may be also or alternatively be performed in conjunction with a mobile computing device, a cloud-based computing system, a server, or the like. That is, the charging assistant 320 may receive data from the remote server and then may perform some analysis or operations described herein with or without the additional computing resources provided by one or more of an onboard computer, mobile device, server, a cloud-computing system, or the like.

In some embodiments, the charging assistant 320 may refer to a facet of a computing application (e.g., charging assistant 320 “app”), which may be stored in the memory of the vehicle’s onboard computing system and/or the driver’s mobile device, and executed by the respective processor to perform the embodiments described herein. The computer application may access the computing resources of the charging assistant 320 to perform its operations or interact with the computing resources of another connected computing system (e.g., cloud-computing system). It should be understood that the term “computer system” refers to the computing resources of a single computer, the partial computing resources of a single computer, a plurality of computers communicating with one another, or a network of remote servers.

In the example of FIG. 3, the first driver 310 is shown interacting with the charging assistant 320 via components of the driver interface system 352. The first driver 310 can be understood to be enroute to some final destination (e.g., their home, their school, a business, a friend’s house, etc.) and is intending to stop along the way to refuel. More specifically, the first driver 310 has selected the first charging station as their re-fueling stop. In this case, the first driver 310 may provide one or more inputs to a navigation application (“app”) running on the onboard computing system 350, which registers the first charging station as the vehicle’s planned destination. Thus, some embodiments of the proposed systems include a navigation/mapping application (“navigation app”) accessed via a computing device such as a mobile phone or the vehicle’s onboard computing device. In some embodiments, the navigation app can generate an interactive map by which the first driver 310 can plan their route and identify nearby places of interest (such as fueling stations). In some embodiments, the navigation app and the charging assistant operate collectively as a charging guidance system by which users can select desired charging station endpoints and receive status information or recommendations and/or navigation instructions related to these endpoints.

In response to the driver’s selection of a destination, an onboard GPS can facilitate development and presentation of a route that directs the first EV 240 toward the first charging station. Thus, for purposes of this example, the first EV 240 may now be headed toward, but has not yet arrived at, the first charging station. Upon receiving, at the navigation application, the selection of the destination, the charging assistant 320 can transmit a request to the remote server, which responds with data about a congestion level/queue time associated with the first charging station at this current time, an assessment based on its live/real-time data snapshot for that charging station (e.g., as discussed in FIG. 2). In some embodiments, the remote server can also indicate whether the congestion level or queue time is greater than some threshold, or otherwise transmit to the charging assistant 320 its evaluation as to whether there is an unexpected and unusual wait time associated with the first charging station.

In those cases where there is an indication that the first charging station is experiencing higher than normal (or some other threshold) delays, the charging assistant 320 can notify the driver, for example, via a message shown on the display 352. Thus, the driver receives this information before they arrive at the first charging station. In some other embodiments, in FIG. 3, an audio message 360 can be presented to the driver (e.g., “You have chosen a charging station experiencing longer than normal wait times”). Furthermore, in some embodiments, an interface for the charging assistant 320 can offer a plurality of selectable options by which the driver can decide how to proceed. For purposes of this example, the first driver 310 can select a first option 322 to simply postpone their charging session (e.g., “I’ll charge later”) and remove the first charging station from their navigation itinerary. A second option 324 can allow the first driver 310 to request that the charging assistant 320 (in conjunction with the navigation system or app) identify an alternate, second charging station that is more likely to offer an efficient refueling experience, and reroute the vehicle to this new destination (e.g., “Reroute me to alternate charging station outside of congested area”). Furthermore, a third option 326 offer the driver the opportunity to learn more about the possible causes of the congestion detected at the first charging station (e.g., “Why is this charging station so congested? How much longer will the congestion last? (Initiate Smart Prediction Assistant)”). In this scenario, the first driver 310 selects the third option 326.

Referring next to FIG. 4, in response to the driver’s request for more information about the cause of the congestion, the charging assistant 320 can request that an EV charging context prediction module (“prediction module”) 480 now generate a prediction corresponding to the most likely instigator of the congestion at this specific charging station. In different embodiments, the prediction module 480 can reside at the remote server, accessed over a network 490, or locally onboard the first EV 240. In some embodiments, in order to identify these likeliest factors(s) contributing to the longer wait times/increased congestion, the prediction module 480 can initiate a data pull 450 from one or more sources.

FIG. 4 depicts a bird’s eye view map 440 for the benefit of the reader, representing various roadways 420 that would lead to the first driver’s selected destination (first charging station 210). The first vehicle 240 is currently at a first location/position on a highway. Based on the first charging station’s location, and a preferred route 430 along roadways 420 projected for travel (e.g., based on the output of navigation app’s traffic data and/or the user’s own preferences), the prediction module 480 can request and pull real-time environmental and social data for each roadway (e.g., from an affiliated, government, or third-party database/service) including – for each road of at least route 430 and the surrounding neighborhoods -- real-time traffic 452, real-time weather 454, construction reports/updates 456, and real-time road conditions 458 (e.g., over network 490). For example, if a chemical leak, debris, water main burst, flash flood, or roadwork (among other unexpected/unplanned events) has occurred or is occurring, such data can be used to determine the charging station has become difficult or unsafe to exit, leading to a build-up of vehicles around that area. This data can also or alternatively be supplied by a wide range of sensor data collected by vehicles currently traveling through those areas and V2V systems connected to the remote server, enabling a crowd-sourced repository that is highly accurate and current. Thus, in different embodiments, a request for the data pull can be sent to and performed by the remote server, and then shared back with the prediction module 480 over a network.

In different embodiments, there may be other conditions that can contribute to local congestion other than environmental factors. For example, in some embodiments, the prediction module 480 can access news coverage 462 from local stations and websites to identify breaking news for the area, as well as social media 464 sources that are linked to the local region. These sources can identify, among other occurrences, whether any events such as funerals or various “pop-ups” are taking place (e.g., conferences, parades, fairs, marches, flash mobs, protests, meetings, performances, entertainment, etc.). For purposes of this application, the term “pop-up” is used to describe events or incidents that occur as a result of the implementation of a project revolving around temporality and spontaneity, and often temporarily transform public space to meet one or more community goals. It can be appreciated that a spontaneous, unplanned protest or demonstration that appears suddenly in a public space, often with little to no prior notice, can significantly impact the traffic flow in and around that area. More specifically, because pop-up events appear quite suddenly and – unlike traditional events – are not typically widely advertised beforehand (creating a sense of surprise and urgency), there may be no way to plan ahead for them. Furthermore, pop-up events can occur at unconventional location, making them difficult to anticipate. For example, pop-up marches can occur in unexpected places like busy intersections, public squares, or even inside a store, depending on the message they want to convey. Some non-limiting examples may include (1) a group of activists suddenly gathering outside a government building to protest a new policy; (2) a flash mob style demonstration in a shopping mall to raise awareness for a social cause; (3) quick protest outside a company headquarters following a controversial news announcement, etc. Because organizers of these types of events leverage social media to quickly spread the word about the protest once it starts, encouraging people to join in, the prediction module 480 can be configured to scan a variety of such sources (e.g., Facebook®, Instagram®, Twitter®, etc.) for keywords related to the area around the designated charging station (e.g., for names of roads that are around a preselected radius of the charging station, the name of the charging station, the names of high-profile persons, shopping centers, merchants, and businesses in the area, etc.) to detect whether such a pop-up might be occurring. The radius can be selected by the driver or be a default value that limits the search to a “local” (e.g., within a block radius, within 2-3 blocks, within 5 blocks, 10 blocks, within a quarter of a mile radius, half a mile, within one mile, within two miles, etc.).

Furthermore, in some embodiments, the prediction module 480 can access local reports of criminal / policy activity 460, including community alerts and other law enforcement notifications, e.g., via radio scan, websites, social media, among others. Such information can be used to determine whether any lockdowns, heavy police, fire, paramedics or other emergency service presence, road shutdowns or detours, or neighborhood blockades (collectively referred to as emergency responder activity-events) may be in place.

In different embodiments, the prediction module 480 is trained to identify, based on this real-time broad spectrum of local-centric information, one or more potential causes contributing to the congestion detected at and around the targeted first charging station 210. The prediction module 480 can select one or two of the most likely events causing the congestion and present this assessment to the driver via the driver interface system.

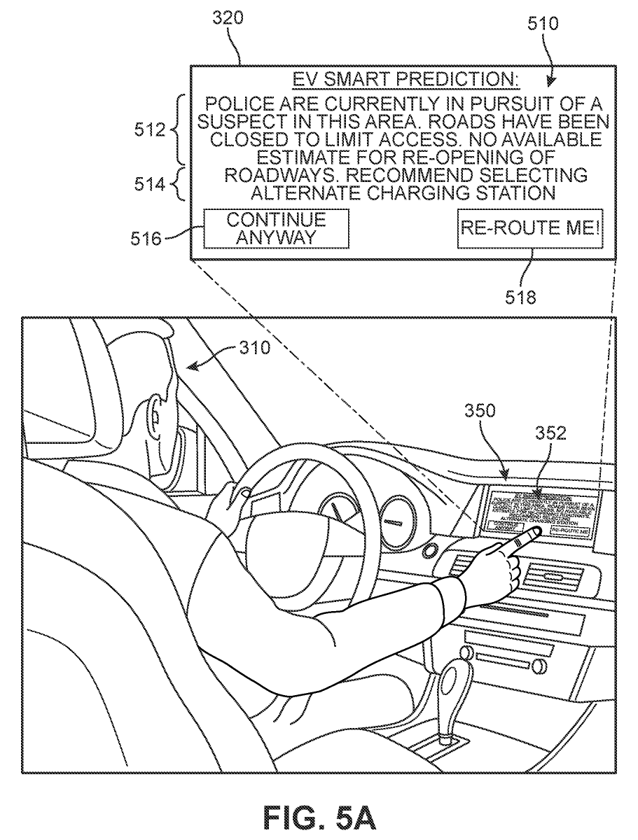

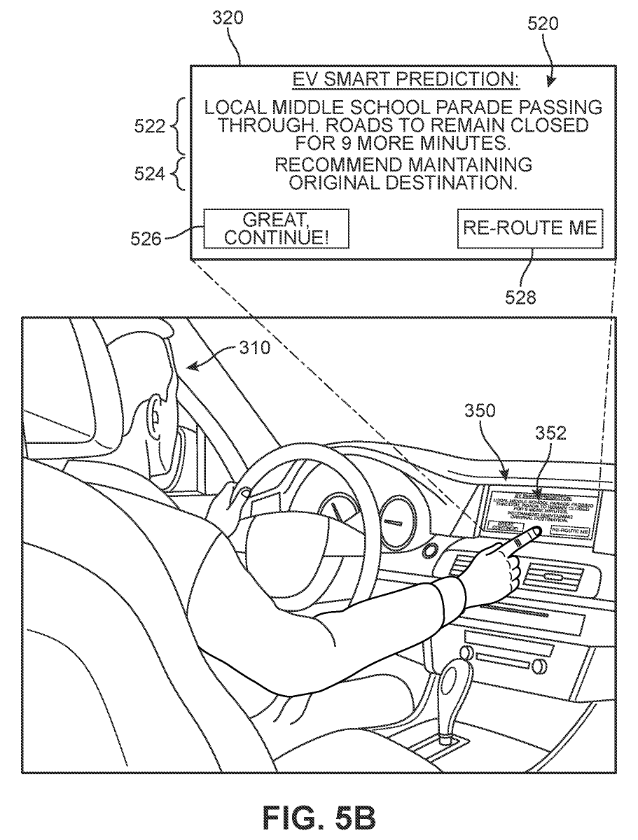

Furthermore, in some embodiments, the output of prediction module 480 can be used by the charging assistant 320 to provide a tailored recommendation to the driver about their next steps. Turning now to FIGS. 5A and 5B, two examples of recommendation strategies are shown for purposes of illustration. In FIG. 5A, a first output 510 of the prediction module indicated the congestion’s most likely cause 512 was related to police activity (e.g., “Police are currently in pursuit of a suspect in this area. Roads have been closed to limit access. No available estimate for re-opening roadways.”). In this case, the prediction module determines that there is very little basis for defining an end time to this event, or that the event appears to have an indefinite duration. In response to this assessment, a first recommendation type 514 can be generated, advising the driver to bypass this area (e.g., “Recommend selecting alternate charging station”), with a first selectable option 516 to override and continue toward the first charging station, and a second selectable option 518 to consent to the recommended course of action and have navigation systems initiate a diversion to an alternate charging station 472.

On the other hand, there may be cases where the prediction module determines other sources have led to the congestion. As an alternate example, in FIG. 5B, a second output 520 of the prediction module indicates the congestion’s most likely cause 522 was related to a pop-up social event (e.g., “Local middle school parade passing through. Roads to remain closed for approximately 9 more minutes.”). In this case, the prediction module determines that, based on the flow of traffic, the category of the event, and the size of the crowd and its progression from a first point to an endpoint (e.g., back to the middle school), the event will terminate in less than 10 minutes.

In response to this assessment, a second recommendation type 524 can be generated, advising the driver to continue to the first charging station (e.g., “Recommend maintaining original destination”), with a first selectable option 526 to accept and continue toward the first charging station, and a second selectable option 528 to override and have navigation systems initiate a diversion to an alternate charging station. Thus, for events that are classified as typically having a short duration and wrap up in a limited time, the recommendation may encourage the driver to stay the course. In different embodiments, this recommendation can be based on the distance/time remaining before the driver reaches the area impacted, the estimated wait time that has been calculated, the degree of congestion that has built up due to the event, the distance/time that would be added were the driver to divert to a different charging station, the SoC (state of charge) of their battery and whether the wait time will deplete the fuel more or the travel to the new charging station would more greatly deplete the fuel, etc.

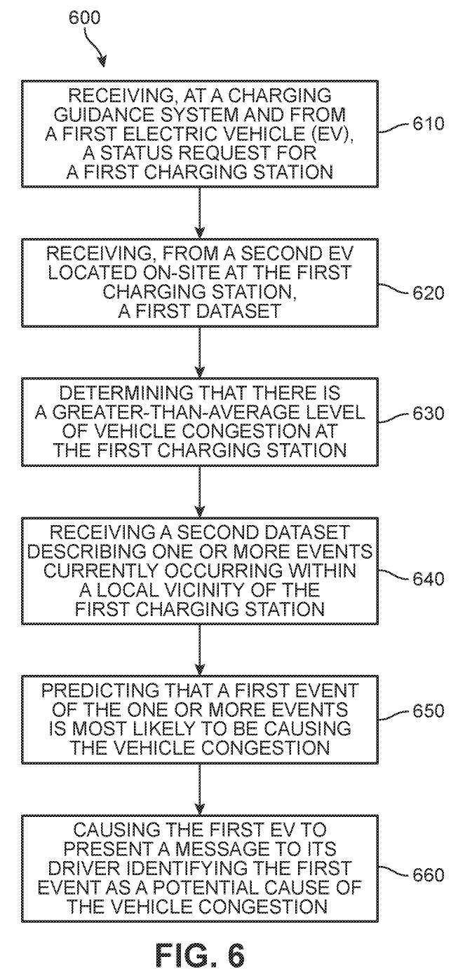

FIG. 6 is a flow chart illustrating an embodiment of a method 600 for generating intelligent and dynamic predictions to facilitate vehicle charging station selections. At 610, the method may include receiving, at a charging guidance system and from a first electric vehicle (EV), a status request for a first charging station. At 620, the method includes receiving, at the charging guidance system and from a second EV located on-site at the first charging station, a first dataset collected via an onboard sensor of the second EV, and at 630 the method includes determining, at the charging guidance system and based on the first dataset, that there is a greater-than-average level of vehicle congestion at the first charging station. The method 600 also includes at 640, receiving, at the charging guidance system, a second dataset describing one or more events currently occurring within a local vicinity of the first charging station. In addition, at 650, the method includes predicting, at the charging guidance system, that a first event of the one or more events is most likely to be causing the vehicle congestion, and at 660, causing the first EV to present a message to its driver identifying the first event as a potential cause of the vehicle congestion at the first charging station.

In different embodiments, the method 600 may include additional processes or aspects. In one example, the first dataset is audio data collected from a microphone of the second EV. In another example, the method further includes determining there is the greater-than-average level of vehicle congestion at the first charging station further includes detecting, in the audio data, sounds associated with activity of electric battery cooling systems around the second EV. In some embodiments, the first dataset is image data collected from a camera of the second EV. In different embodiments, the method also includes determining there is the greater-than-average level of vehicle congestion at the first charging station further includes detecting, in the image data, features showing multiple EVs charging and/or waiting to charge at the first charging station. In some embodiments, the method can include estimating a remaining duration of the first event; and presenting the estimation to the driver of the first EV. In another embodiment, the method may also include generating a recommended strategy for selecting a charging station based on the estimation; and presenting the recommended strategy to the driver of the first EV. In different embodiments, the event can be an impromptu event. In another example, the event can refer to a pop-up event. In some embodiments, the event is related to emergency responder activity. In one example, the event type/classification/category and/or event details are associated with activity with an indefinite duration, such that the system recommends diverting to an alternate charging station. In some embodiments, the event type/classification/category and/or details are associated with activity anticipated to last for less than a preselected duration threshold, such that the system recommends continuing to the target charging station. It is further noted that pop-up events are not limited to a crowding of civilian people or drivers, but may include gatherings of vehicles, animals, equipment, children, celebrities, law enforcement, etc.

As a general matter, embodiments of the server and service for the concierge systems provided herein are described below. As a general matter, the server may include circuitry, a memory, an I/O device, and a network interface. The circuitry may be coupled to the memory, the I/O device, and the network interface, through wired or wireless connections of the communication networks.

The circuitry may include any suitable special-purpose or general-purpose computer, computing entity, or processing device including various computer hardware or software modules and may be configured to execute instructions stored on any applicable computer-readable storage media (for example the memory). The circuitry may be implemented based on a number of processor technologies known in the art. For example, the circuitry may include a microprocessor, a microcontroller, a digital signal processor (DSP), an application-specific integrated circuit (ASIC), a Field- Programmable Gate Array (FPGA), or any other digital or analog circuitry configured to interpret and/or to execute program instructions and/or to process data. The circuitry may include any number of processors configured to, individually or collectively, perform any number of operations of the server, as described in the present disclosure. Examples of the circuitry may include a Central Processing Unit (CPU), a Graphical Processing Unit (GPU), an x86-based processor, an x64-based processor, a Reduced Instruction Set Computing (RISC) processor, a Complex Instruction Set Computing (CISC) processor, and/or other hardware processors.

The memory may include suitable logic, circuitry, interfaces, and/or code that may be configured to store the set of instructions executable by the circuitry. The memory may be configured to store the registration information for the transfer devices. The memory may be further configured to store the electric charging information, the renewable credit information, and the monetary information. Examples of implementation of the memory may include, but are not limited to, Random Access Memory (RAM), Read Only Memory (ROM), Hard Disk Drive (HDD), a Solid-State Drive (SSD), a CPU cache, and/or a Secure Digital (SD) card.

The I/O device may include suitable logic, circuitry, interfaces, and/or code that may be configured to receive user inputs and generate outputs in response to the received user inputs. The I/O device may receive the registration information associated with a new electric charging facility device as the user-input. For example, the server may receive the user-input from an executive of the organization associated with or handling the server for the REC management. The I/O device may include various input and output devices, may be configured to communicate with the circuitry. Examples of the I/O device may include, but are not limited to, a touch screen, a keyboard, a mouse, a joystick, a microphone, a display device, a speaker, and/or an image sensor.

The network interface may include suitable logic, circuitry, and interfaces that may be configured to facilitate communication between the circuitry, the fueling facility devices, the electronic device of the OEMs, the electric grid device of an electric grid, the communication device of the renewable energy generation sources, and the electronic apparatus of the vehicle, via the communication network. The network interface may be implemented by use of various known technologies to support wired or wireless communication of the server with the communication network. The network interface may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface may be configured to communicate via wireless communication with networks, such as the Internet, an Intranet or a wireless network, such as a cellular telephone network, a wireless local area network (LAN), and a metropolitan area network (MAN). The wireless communication may be configured to use one or more of a communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging and a Short Message Service (SMS).

While the server in this case includes the circuitry, the memory, the I/O device, and the network interface, the disclosure should not be construed as limiting the server and may include more or less components to perform the same or other functions of the server. Details of the other functions and the components have been omitted from the disclosure for the sake of brevity. The functions or operations executed by the server may be performed by the circuitry. It should be understood that the server may be combined with the transfer devices to form a system. The transfer devices may be communicably coupled with the network Interface, via a communication network.

The following includes definitions of selected terms employed herein. The definitions include various examples and/or forms of components that fall within the scope of a term and that may be used for implementation. The examples are not intended to be limiting. Aspects of the present disclosure may be implemented using hardware, software, or a combination thereof and may be implemented in one or more computer systems or other processing systems. In one example variation, aspects described herein may be directed toward one or more computer systems capable of carrying out the functionality described herein. An example of such a computer system includes one or more processors. A “processor”, as used herein, generally processes signals and performs general computing and arithmetic functions. Signals processed by the processor may include digital signals, data signals, computer instructions, processor instructions, messages, a bit, a bit stream, or other means that may be received, transmitted and/or detected. Generally, the processor may be a variety of various processors including multiple single and multicore processors and co-processors and other multiple single and multicore processor and co-processor architectures. The processor may include various modules to execute various functions.

The apparatus and methods described herein and illustrated in the accompanying drawings by various blocks, modules, components, circuits, steps, processes, algorithms, etc. (collectively referred to as “elements”) may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented with a “processing system” that includes one or more processors. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

The processor may be connected to a communication infrastructure (e.g., a communications bus, cross-over bar, or network). Various software aspects are described in terms of this example computer system. After reading this description, it will become apparent to a person skilled in the relevant art(s) how to implement aspects described herein using other computer systems and/or architectures.

Computer system may include a display interface that forwards graphics, text, and other data from the communication infrastructure (or from a frame buffer) for display on a display unit. Display unit may include display, in one example. Computer system also includes a main memory, e.g., random access memory (RAM), and may also include a secondary memory. The secondary memory may include, e.g., a hard disk drive and/or a removable storage drive, representing a floppy disk drive, a magnetic tape drive, an optical disk drive, etc. The removable storage drive reads from and/or writes to a removable storage module in a well-known manner. Removable storage module, represents a floppy disk, magnetic tape, optical disk, etc., which is read by and written to removable storage drive. As will be appreciated, the removable storage module includes a computer usable storage medium having stored therein computer software and/or data.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals, which may be electronic, electromagnetic, optical or other signals capable of being received by communications interface. These signals are provided to communications interface via a communications path (e.g., channel). This path carries signals and may be implemented using wire or cable, fiber optics, a telephone line, a cellular link, a radio frequency (RF) link and/or other communications channels. The terms “computer program medium” and “computer usable medium” are used to refer generally to media such as a removable storage drive, a hard disk installed in a hard disk drive, and/or signals. These computer program products provide software to the computer system. Aspects described herein may be directed to such computer program products. Communications device may include communications interface.

Computer programs (also referred to as computer control logic) are stored in main memory and/or secondary memory. Computer programs may also be received via communications interface. Such computer programs, when executed, enable the computer system to perform various features in accordance with aspects described herein. In particular, the computer programs, when executed, enable the processor to perform such features. Accordingly, such computer programs represent controllers of the computer system.

In variations where aspects described herein are implemented using software, the software may be stored in a computer program product and loaded into computer system using removable storage drive, hard disk drive, or communications interface. The control logic (software), when executed by the processor, causes the processor to perform the functions in accordance with aspects described herein. In another variation, aspects are implemented primarily in hardware using, e.g., hardware components, such as application specific integrated circuits (ASICs). Implementation of the hardware state machine so as to perform the functions described herein will be apparent to persons skilled in the relevant art(s). In yet another example variation, aspects described herein are implemented using a combination of both hardware and software.

The foregoing disclosure of the preferred embodiments has been presented for purposes of illustration and description. It is not intended to be exhaustive or to limit the embodiments to the precise forms disclosed. Many variations and modifications of the embodiments described herein will be apparent to one of ordinary skill in the art in light of the above disclosure.

While various embodiments have been described, the description is intended to be exemplary, rather than limiting, and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

Further, in describing representative embodiments, the specification may have presented a method and/or process as a particular sequence of steps or processes. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art may readily appreciate that the sequences may be varied and still remain within the spirit and scope of the present embodiments.

1. A method for generating intelligent and dynamic predictions to facilitate vehicle charging station selections, the method comprising:
receiving, at a charging guidance system and from a first electric vehicle (EV), a status request for a first charging station;
receiving, at the charging guidance system and from a second EV located on-site at the first charging station, a first dataset collected via an onboard sensor of the second EV;
determining, at the charging guidance system and based on the first dataset, that there is a greater-than-average level of vehicle congestion at the first charging station;
receiving, at the charging guidance system, a second dataset describing one or more events currently occurring within a local vicinity of the first charging station;
predicting, at the charging guidance system, that a first event of the one or more events is most likely to be causing the vehicle congestion; and
causing the first EV to present a message to its driver identifying the first event as a potential cause of the vehicle congestion at the first charging station.

2. The method of claim 1, wherein the first dataset is audio data collected from a microphone of the second EV.

3. The method of claim 2, wherein determining there is the greater-than-average level of vehicle congestion at the first charging station further includes detecting, in the audio data, sounds associated with activity of electric battery cooling systems around the second EV.

4. The method of claim 1, wherein the first dataset is image data collected from a camera of the second EV.

5. The method of claim 4, wherein determining there is the greater-than-average level of vehicle congestion at the first charging station further includes detecting, in the image data, features showing multiple EVs charging and/or waiting to charge at the first charging station.

6. The method of claim 1, further comprising:
estimating a remaining duration of the first event; and
presenting the estimation to the driver of the first EV.

7. The method of claim 6, further comprising:
generating a recommended strategy for selecting a charging station based on the estimation; and
presenting the recommended strategy to the driver of the first EV.

8. A non-transitory computer-readable medium storing software comprising instructions executable by one or more computers which, upon such execution, cause the one or more computers to generate intelligent and dynamic predictions to facilitate vehicle charging station selections by:
receive, at a charging guidance system and from a first electric vehicle (EV), a status request for a first charging station;
receive, at the charging guidance system and from a second EV located on-site at the first charging station, a first dataset collected via an onboard sensor of the second EV;
determine, at the charging guidance system and based on the first dataset, that there is a greater-than-average level of vehicle congestion at the first charging station;
receive, at the charging guidance system, a second dataset describing one or more events currently occurring within a local vicinity of the first charging station;
predict, at the charging guidance system, that a first event of the one or more events is most likely to be causing the vehicle congestion; and
cause the first EV to present a message to its driver identifying the first event as a potential cause of the vehicle congestion at the first charging station.

9. The non-transitory computer-readable medium of claim 8, wherein the first dataset is audio data collected from a microphone of the second EV.

10. The non-transitory computer-readable medium of claim 9, wherein the instructions further cause the one or more computers to determine there is the greater-than-average level of vehicle congestion at the first charging station by detecting, in the audio data, sounds associated with activity of electric battery cooling systems around the second EV.

11. The non-transitory computer-readable medium of claim 8, wherein the first dataset is image data collected from a camera of the second EV.

12. The non-transitory computer-readable medium of claim 11, wherein the instructions further cause the one or more computers to determine there is the greater-than-average level of vehicle congestion at the first charging station further includes detecting, in the image data, features showing multiple EVs charging and/or waiting to charge at the first charging station.

13. The non-transitory computer-readable medium of claim 8, wherein the instructions further cause the one or more computers to:
estimate a remaining duration of the first event; and
present the estimation to the driver of the first EV.

14. The non-transitory computer-readable medium of claim 13, wherein the instructions further cause the one or more computers to:
generate a recommended strategy for selecting a charging station based on the estimation; and
present the recommended strategy to the driver of the first EV.

15. A system for generating intelligent and dynamic predictions to facilitate vehicle charging station selections comprising one or more computers and one or more storage devices storing instructions that are operable, when executed by the one or more computers, to cause the one or more computers to:
receive, at a charging guidance system and from a first electric vehicle (EV), a status request for a first charging station;
receive, at the charging guidance system and from a second EV located on-site at the first charging station, a first dataset collected via an onboard sensor of the second EV;
determine, at the charging guidance system and based on the first dataset, that there is a greater-than-average level of vehicle congestion at the first charging station;
receive, at the charging guidance system, a second dataset describing one or more events currently occurring within a local vicinity of the first charging station;
predict, at the charging guidance system, that a first event of the one or more events is most likely to be causing the vehicle congestion; and
cause the first EV to present a message to its driver identifying the first event as a potential cause of the vehicle congestion at the first charging station.

16. The system of claim 15, wherein the first dataset is audio data collected from a microphone of the second EV.

17. The system of claim 16, wherein the instructions further cause the one or more computers to determine there is the greater-than- average level of vehicle congestion at the first charging station by detecting, in the audio data, sounds associated with activity of electric battery cooling systems around the second EV.

18. The system of claim 15, wherein the first dataset is image data collected from a camera of the second EV.

19. The system of claim 18, wherein the instructions further cause the one or more computers to determine there is the greater-than- average level of vehicle congestion at the first charging station further includes detecting, in the image data, features showing multiple EVs charging and/or waiting to charge at the first charging station.

20. The system of claim 16, wherein the instructions further cause the one or more computers to:
estimate a remaining duration of the first event; and
present the estimation to the driver of the first EV.
